(19) United States
(12) Patent Application Publication
(10) Pub. No.: US 2025/0131084 A1
(43) Pub. Date: Apr. 24, 2025

(54) METHOD FOR AGGREGATING SECURITY ALERTS TO REDUCE ALERT FATIGUE AND TO HELP ALERT TRIAGING

(71) Applicant: VMware, Inc., Palo Alto, CA (US)

(72) Inventors: Jue MO, Boca Raton, FL (US); Aditya CHOUDHARY, San Jose, CA (US); Jonathan James OLIVER, Kew (AU); Raghav BATTA, Livermore, CA (US); Lalit Prithviraj JAIN, Cupertino, CA (US)

(21) Appl. No.: 18/491,593

(22) Filed: Oct. 20, 2023

(51) Int. Cl. G06F 21/55; G06F 21/57

(52) U.S. Cl. CPC G06F 21/554; G06F 21/552; G06F 21/577

(57) ABSTRACT

A computer system comprises a plurality of endpoints at which security agents generate security alerts and a machine-learning (ML) system that receives the security alerts from the endpoints and that separates the security alerts into a plurality of clusters, wherein the ML system is configured to execute on a processor of a hardware platform to: determine that a group of first alerts of the security alerts belongs to a first cluster of the clusters; create a first representative alert from metadata of the first alerts belonging to the first cluster; and in response to a security analytics platform evaluating the first representative alert as being harmless to the computer system, store information indicating that all of the first alerts are harmless.

### BACKGROUND

Security operations centers (SOCs) provide services for monitoring computer systems of organizations to detect threats. At SOCs, SOC analysts use a various of security analytics tools to evaluate security alerts. Such tools include security information and event management (SIEM) software, which includes components for automatically evaluating alerts and also components that enable manual evaluation by SOC analysts. Such tools also include correlation engines, which automatically evaluate alerts. The alerts are contextual and identify values of various features, such values being used for determining whether the alerts were generated in response to malicious activity or harmless activity.

The number of alerts generated by security systems is often too large to effectively monitor the computer systems. For example, the number of alerts may far outweigh the number of alerts that a team of SOC analysts can triage in a timely manner. As a result, the SOC analysts may identify malicious activity too late for remediation measures to be effective. Indeed, SOC analysts may not even have a chance to review malicious alerts before related breaches are already underway and detected through other methods. Additionally, in the case of automatic evaluators such as correlation engines, the number of alerts may be too large for the evaluators to determine malicious activity accurately.

In some cases, security systems have adapted by increasing the precision of the rules used for generating alerts. This decreases the number of alerts that are generated because not as many activities of the computer system match the rules and trigger alerts. Such increases in precision also result in less false positives, i.e., less cases in which an alert is triggered by harmless activity. However, such increases in precision typically reduce the capabilities of SOCs to detect malicious activity as attackers often take advantage of such changes. For example, attackers frequently create new malware for which the security systems have not yet incorporated precise rules for detecting. As another example, instead of using malware at all, attackers often break into computer systems and use administrative tools therein such as PowerShell® to encrypt data and blackmail and extort organizations. Such attacks, known as living-off-the-land (LOTL) attacks, are difficult to detect with precise rules.

In other cases, instead of incorporating more precise rules, security systems have leveraged “threat scores” that are associated with the rules, e.g., values between 1 and 10. Such scores have typically been determined by security analysts who write the rules. The scores have been used to prioritize alerts, alerts that are generated in response to rules with high threat scores being evaluated before alerts that are generated in response to rules with low threat scores. However, this manner of applying threat scores has been notoriously inconsistent at prioritizing alerts. Indeed, activity that is expected and likely harmless for a computer system of one organization may be unusual and likely malicious for a computer system of another organization.

In sum, merely reducing the coverage of alerts with highly precise rules leaves computer systems vulnerable to malicious activity. Meanwhile, traditional techniques for prioritizing alerts such as applying predetermined threat scores have proven to be ineffective for intelligently prioritizing alerts for evaluation by security analytics platforms. A method and computer system are needed for more effectively processing large numbers of alerts for evaluation such that malicious activity may be identified and then remediated more quickly.

### SUMMARY

One or more embodiments provide a computer system comprising a plurality of endpoints at which security agents generate security alerts. The computer system further comprises a machine-learning (ML) system that receives the security alerts from the endpoints and that separates the security alerts into a plurality of clusters. The ML system is configured to execute on a processor of a hardware platform to: determine that a group of first alerts of the security alerts belongs to a first cluster of the clusters; create a first representative alert from metadata of the first alerts belonging to the first cluster; and in response to a security analytics platform evaluating the first representative alert as being harmless to the computer system, store information indicating that all of the first alerts are harmless.

Further embodiments include a method of aggregating security alerts as the above computer system is configured to perform and a non-transitory computer-readable storage medium comprising instructions that cause a computer system to carry out such a method.

### BRIEF DESCRIPTION OF THE DRAWINGS

FIG. 1 is a block diagram of a virtualized computer system in which embodiments may be implemented.

FIG. 2 is a block diagram illustrating software components of an ML system of the virtualized computer system, the ML system being configured to perform embodiments.

FIG. 3 is a block diagram of a database of the ML system that stores alerts received from endpoints of the virtualized computer system.

FIG. 4 is a flow diagram of a method performed by the ML system during a training period to configure an ML model to cluster alerts, according to embodiments.

FIG. 5 is a flow diagram of a method performed by the ML system during an operational period to aggregate alerts based on clustering, according to embodiments.

FIG. 6 is a flow diagram of a method performed by the ML system to label alerts based on evaluations by a security analytics platform, according to embodiments.

### DETAILED DESCRIPTION

Techniques for aggregating security alerts are described. Alerts are generated at endpoints of a customer environment. Some of those alerts are generated in response to malicious activity and are referred to herein as “malicious alerts.” Other alerts are generated in response to harmless activity and are referred to herein as “harmless alerts.” However, before those alerts are evaluated at a security analytics platform, the nature of the alerts is unknown.

According to embodiments, an ML system configures an ML model based on alerts received from the endpoints of the customer environment during a training period. The ML model is a clustering system or an artificial neural network (ANN) that is trained to separate the alerts into a plurality of clusters based on at least one attribute of the alerts. The alerts are clustered in a manner that minimizes inter-cluster differences over a predetermined set of features of the alerts. Then, during an operational period, each time a new alert is received from the customer environment, the ML system assigns the alert to a cluster according to the clustering method used during the training period. The ML system performs such clustering over predetermined time intervals of the operational period, e.g., one-day intervals.

At the end of each interval, for each of the clusters, the ML system aggregates alerts received over the time interval to create a single alert that captures information of the alerts without duplicated information. The ML system then transmits the aggregated (representative) alerts to a security analytics platform for evaluation. The representative alerts are evaluated at the security analytics platform instead of all the individual alerts, and evaluations of the representative alerts are then received from the security analytics platform.

Upon receiving an evaluation from the security analytics platform, the ML system labels all the corresponding alerts accordingly. If the evaluation is that a representative alert is harmless, the ML system labels the corresponding alerts as harmless. Otherwise, if the evaluation is that the representative alert is malicious, the ML system labels the corresponding alerts as malicious. Because the differences among the individual alerts across features of interest is minimized by the clustering, such labeling is highly accurate. In other words, it is highly unlikely that the corresponding alerts of the same representative alert include both malicious and harmless alerts.

Embodiments significantly reduce the amount of alerts that the security analytics platform must triage to adequately monitor the customer environment. Embodiments are thus highly scalable with increasing numbers of alerts generated at endpoints of the customer environment. Accordingly, SOC analysts identify and initiate remediation measures in response to malicious activity more quickly. In the case of automatic evaluators such as correlation engines, the reduced number of alerts improves the accuracy of evaluations, i.e., reduces false positives when evaluating alerts as malicious and false negatives when evaluating alerts as harmless. These and further aspects of the invention are discussed below with respect to the drawings.

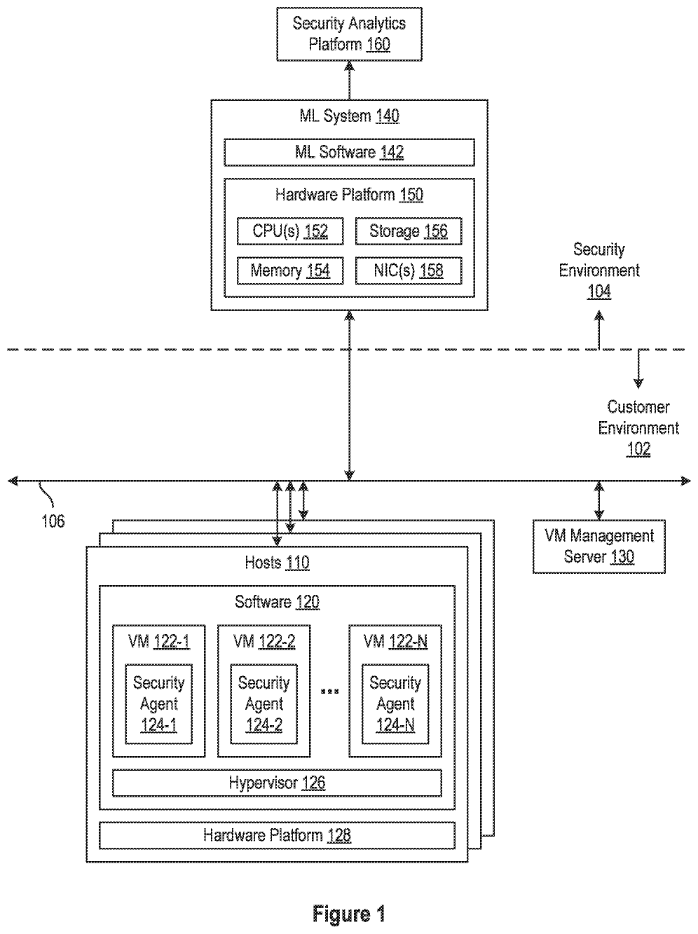

FIG. 1 is a block diagram of a virtualized computer system in which embodiments may be implemented. The virtualized computer system includes a customer environment 102 and an external security environment 104. As used herein, a “customer” is an organization that has subscribed to security services offered through an ML system 140 of security environment 104. A “customer environment” is the customer's own information technology (IT) environment (commonly referred to as “on-premise”), a private cloud managed by the customer, a public cloud managed for the customer by another organization, or any combination of these. Although security environment 104 is illustrated as external to customer environment 102, any components of security environment 104 may instead be implemented within customer environment 102.

Customer environment 102 includes a plurality of host computers 110, referred to herein simply as “hosts,” and a virtual machine (VM) management server 130. Each of hosts 110 is constructed on a hardware platform 128 such as an x86 architecture platform. Hardware platform 128 includes conventional components of a computing device (not shown), such as one or more central processing units (CPUs), memory such as random-access memory (RAM), local storage such as one or more magnetic drives or solid-state drives (SSDs), and one or more network interface cards (NICs). The NICs enable hosts 110 to communicate with each other and with other devices over a network 106 such as a local area network (LAN).

Hardware platform 128 of each of hosts 110 supports software 120. Software 120 includes a hypervisor 126, which is a virtualization software layer. Hypervisor 126 supports a VM execution space within which VMs 122 are concurrently instantiated and executed. One example of hypervisor 126 is a VMware ESX® hypervisor, available from VMware, Inc.

VMs 122 include respective security agents 124, which generate alerts in response to suspicious activity. Although the disclosure is described with reference to VMs as endpoints of customer environment 102, the teachings herein also apply to nonvirtualized computers and to other types of virtual computing instances. Such virtual computing instances include containers, Docker® containers, data compute nodes, and isolated user space instances for which behavior is monitored to discover malicious activities. Furthermore, although FIG. 1 illustrates VMs 122 and security agents 124 in software 120, the teachings herein also apply to security agents 124 implemented in firmware for hardware platform 128.

VM management server 130 logically groups hosts 110 into a cluster to perform cluster-level tasks such as provisioning and managing VMs 122 and migrating VMs 122 from one of hosts 110 to another. VM management server 130 communicates with hosts 110 via a management network (not shown) provisioned from network 106. VM management server 130 may be, e.g., one of hosts 110 or one of VMs 122. One example of VM management server 130 is VMware vCenter Server,® available from VMware, Inc.

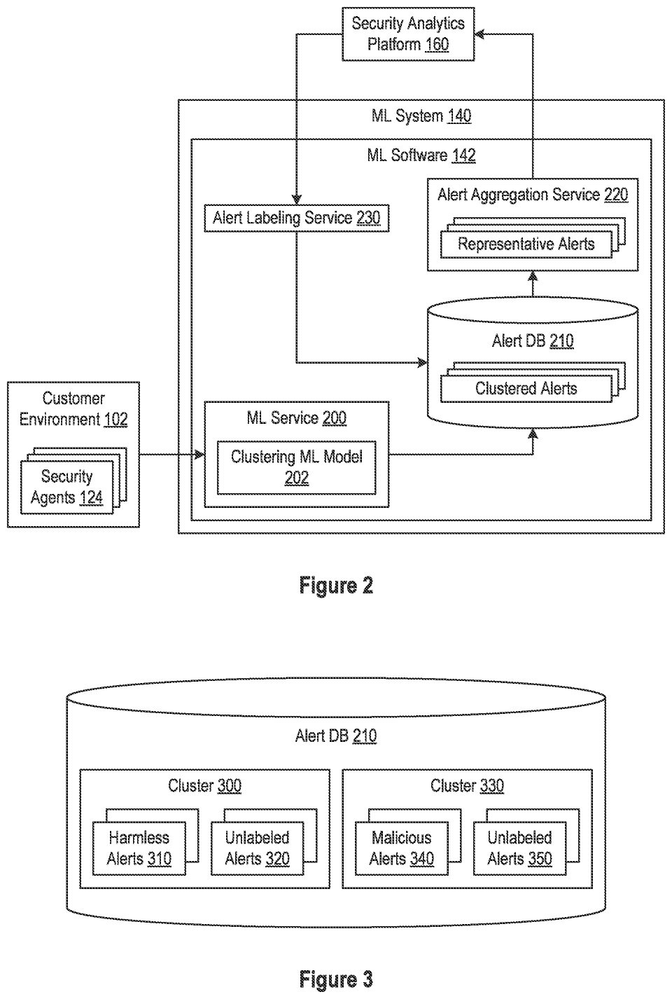

ML system 140 provides security services to VMs 122. ML system 140 communicates with VMs 122 over a public network (not shown), e.g., the Internet, to obtain alerts generated by security agents 124. Alternatively, if implemented within customer environment 102, ML system 140 communicates with VMs 122 over one or more private networks such as network 106. ML system 140 includes ML software 142, which is discussed further below in conjunction with FIG. 2. ML software 142 runs in one or more VMs or containers and is deployed on a hardware platform 150 of security environment 104.

Hardware platform 150 includes the conventional components of a computing device discussed above with respect to hardware platform 128, including a CPU(s) 152, memory 154, local storage 156, and a NIC(s) 158 for communicating with hosts 110. CPU(s) 152 are configured to execute instructions such as executable instructions that perform one or more operations described herein, which may be stored in memory 154. As ML system 140 receives alerts generated at VMs 122, ML system 140 creates representative alerts to transmit to a security analytics platform 160 for evaluation. For example, security analytics platform 160 may be an SOC at which SOC analysts use various security analytics tools to evaluate representative alerts such as SIEM software or correlation engines.

FIG. 2 is a block diagram illustrating components of ML software 142 of ML system 140, which are configured to perform embodiments. Security agents 124 of customer environment 102 generate alerts based on suspicious activities in respective VMs 122 and transmit those alerts to ML system 140, e.g., over the Internet. During a training period of ML system 140, ML system 140 receives alerts generated at customer environment 102 during normal activity thereof. During the training period, an ML service 200 trains a clustering ML model 202 such as an ANN to separate the alerts into clusters. ML service 200 then stores the clusters of alerts in an alert database (DB) 210. ML model 202 clusters the alerts based on at least one attribute such as entire command lines that triggered the alerts. Each cluster may correspond to a single one of VMs 122, e.g., because certain behavior is typical for one of VMs 122 but an outlier (suspicious) for others of VMs 122.

During an operational period of ML system 140 (after the training period), new alerts are continually received by ML system 140 from security agents 124 as VMs 122 continue to execute. A new alert is first received at ML service 200, which assigns the new alert to one of the clusters of alert DB 210. After a predetermined time interval of the operational period, e.g., one day, an alert aggregation service 220 aggregates the alerts for each of the clusters of alert DB 210. A single alert created based on metadata of alerts of a cluster collected over a time interval of the operational period is referred to herein as a “representative alert.” A representative alert includes information about its corresponding alerts without duplicated information. For example, if command lines of the corresponding alerts all included an identical digital signature, the representative alert only includes a single instance of the digital signature.

Once alert aggregation service 220 creates representative alerts for each of the clusters, alert aggregation service 220 transmits the representative alerts to security analytics platform 160. Security analytics platform 160 evaluates the representative alerts and transmits the evaluations to an alert labeling service 230. Alert labeling service 230 then labels the corresponding alerts in alert DB 210 accordingly. If an evaluation of a representative alert is harmless, alert labeling service 230 labels each of the corresponding alerts as harmless. If the evaluation is malicious, alert labeling service 230 labels each of the corresponding alerts as malicious.

Alert aggregation service 220 prioritizes representative alerts based on past evaluations for respective clusters. For example, in a previous interval of the operational period, a representative alert for a first cluster may have been evaluated as harmless, and a representative alert for a second cluster may have been evaluated as malicious. In a new interval of the operational period, ML system 140 may then receive new alerts that are assigned by ML service 200 to the first and second clusters. Alert aggregation service 220 creates new representative alerts, a first representative alert based on metadata of the new alerts assigned to the first cluster and a second representative alert based on metadata of the new alerts assigned to the second cluster. Alert aggregation service 220 prioritizes transmitting the first representative alert to security analytics platform 160 over transmitting the second representative alert. In other words, alert aggregation service 220 may transmit the second representative alert first because the second cluster has malicious alerts.

FIG. 3 is a block diagram of alert DB 210. For simplicity, FIG. 3 illustrates two clusters: a cluster 300 and a cluster 330. In practice, alert DB 210 includes many more clusters. In the example of FIG. 3, multiple time intervals of the operational period have elapsed. Clusters 300 and 330 have thus been assigned alerts in previous intervals (alerts 310 and 340, respectively) and during a current interval (alerts 320 and 350, respectively).

For both clusters, the alerts received during the previous intervals have been labeled based on evaluations of corresponding representative alerts. Security analytics platform 160 evaluated a representative alert corresponding to alerts 310 as being harmless, so alert labeling service 230 labeled alerts 310 of cluster 300 as being harmless. Security analytics platform 160 evaluated a representative alert corresponding to alerts 340 as being malicious, so alert labeling service 230 labeled alerts 340 of cluster 330 as being malicious. Alerts 320 and 350, which have been received during the current interval of the operational period, have not yet been labeled because security analytics platform 160 has not yet evaluated representative alerts therefor.

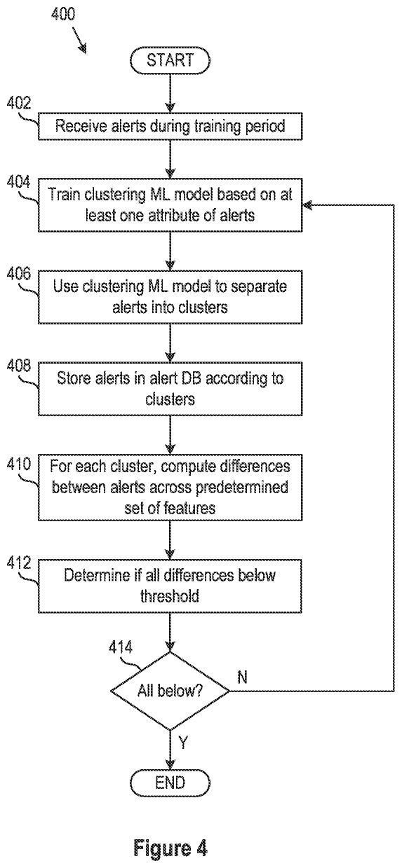

FIG. 4 is a flow diagram of a method 400 performed by ML service 200 of ML system 140 during the training period to configure clustering ML model 202, according to embodiments. At step 402, ML service 200 receives alerts during the training period. The duration of the training period may be a day for example, but such duration is configurable. At step 404, ML service 200 trains clustering ML model 202 based on at least one attribute of the alerts. According to embodiments discussed herein, the at least one attribute for each of the alerts is an entire command line that triggered the alert, but the at least one attribute may be something else.

Regardless of which attribute(s) are used for the clustering, the clustering may be performed by a variety of methods. For example, if command lines are used for clustering, a trend locality sensitive hash (TLSH) may be calculated for the command line of each alert. Clusters are then created that each includes a TLSH value as the center of the cluster. Membership to that cluster is then based on whether a particular alert's TLSH is within a threshold distance of the center for that cluster. Applying TLSHs is merely one method of clustering alerts, however.

At step 406, ML service 200 uses clustering ML model 202 to separate the alerts into clusters. As mentioned above, each cluster may correspond to a single one of VMs 122. At step 408, ML service 200 stores the alerts in alert DB 210 according to the clusters. At step 410, for each of the clusters, ML service 200 computes differences such as variances between alerts across a predetermined set of features. For example, the features may include whether digital signatures were present in the command lines that triggered the alerts and reputations of processes in the command lines. ML service 200 may calculate a plurality of individual differences such as variances for each of the clusters, i.e., a difference for each of such features. ML service 200 may instead calculate a single overall difference such as an overall variance for each of the clusters, i.e., a difference across all features.

At step 412, ML service 200 determines if all the differences computed in step 410 are below a predetermined threshold. Clustering according to entire command lines is likely sufficient for minimizing such inter-cluster differences. Minimizing inter-cluster differences allows for effectively aggregating alerts of clusters during the operation period later. In other words, minimizing inter-cluster differences reduces the likelihood of a single cluster have a mix of harmless and malicious alerts. At step 414, if not all the differences are below the threshold, method 400 returns to step 404, and ML service 200 trains clustering ML model 202 based on a different attribute(s) of the alerts. Otherwise, if all the differences are below the threshold, method 400 ends, and the training period of ML system 140 is complete.

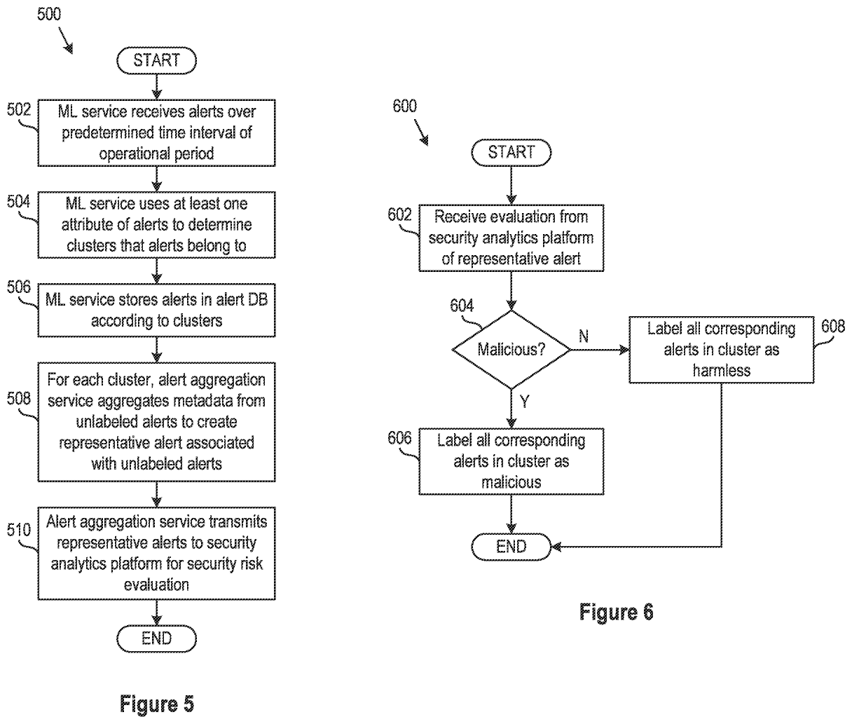

FIG. 5 is a flow diagram of a method 500 performed by ML system 140 during the operational period to aggregate alerts based on clustering, according to embodiments. At step 502, ML service 200 receives alerts over a predetermined time interval of the operational period. For example, the time interval may be a day. However, each time interval of the operational period may be adjusted to change the frequency of transmitting representative alerts to security analytics platform 160.

At step 504, ML service 200 uses at least one attribute of the alerts to determine which clusters the alerts belong to. The at least one attribute used during the operational period is the same as that/those used for clustering during the training period, which has been determined to minimize inter-cluster differences of a plurality of alert features. Continuing the above example of clustering based on TLSHs of command lines, ML service 200 calculates the TLSH of each of the command lines that triggered the alerts. ML service 200 then compares the calculated TLSHs to the centers of the clusters to determine cluster memberships for the alerts.

At step 506, ML service 200 stores the alerts in alert DB 210 according to the determined clusters. At step 508, for each of the clusters, alert aggregation service 220 aggregates metadata from the unlabeled alerts to create a representative alert associated with the unlabeled alerts. The representative alert removes duplicated information across the unlabeled alerts. For example, if each unlabeled alert includes an identical digital signature from a command line that triggered the alert, the representative alert only includes a single instance of the digital signature.

At step 510, alert aggregation service 220 transmits the representative alerts to security analytics platform 160 for security risk evaluation. Alert aggregation service 220 prioritizes some of the representative alerts over others based on past evaluations. For example, alert aggregation service 220 transmits representative alerts for clusters that already have labeled, malicious alerts before transmitting other representative alerts. After step 510, method 500 ends. If any representative alert is a malicious alert, security analytics platform 160 quickly identifies the associated malicious activity and remediates customer environment 102 accordingly.

FIG. 6 is a flow diagram of a method 600 performed by alert labeling service 230 of ML system 140 to label alerts based on evaluations by security analytics platform 160, according to embodiments. At step 602, alert labeling service 230 receives an evaluation from security analytics platform 160 of a representative alert. At step 604, if the evaluation is that the representative alert is malicious, method 600 moves to step 606. At step 606, alert labeling service 230 labels all the corresponding alerts as malicious, i.e., stores information in alert DB 210 indicating that all the corresponding alerts are malicious. The corresponding alerts are those unlabeled alerts of alert DB 210 that were aggregated by alert aggregation service 220 to create the representative alert of which an evaluation was received at step 602.

After step 606, method 600 ends. Returning to step 604, if the evaluation is that the representative alert is harmless, method 600 moves to step 608. At step 608, alert labeling service 230 labels all the corresponding alerts as harmless, i.e., stores information in alert DB 210 indicating that all the corresponding alerts are harmless. After step 608, method 600 ends. The labeling is used later for prioritizing transmitting some representative alerts before others.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying. determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A computer system comprising:
a plurality of endpoints at which security agents generate security alerts; and
a machine-learning (ML) system that receives the security alerts from the endpoints, wherein the ML system separates the security alerts into a plurality of clusters, and wherein the ML system is configured to execute on a processor of a hardware platform to:
determine that a group of first alerts of the security alerts belongs to a first cluster of the clusters;
create a first representative alert from metadata of the first alerts belonging to the first cluster; and
in response to a security analytics platform evaluating the first representative alert as being harmless to the computer system, store information indicating that all of the first alerts are harmless.

2. The computer system of claim 1, wherein the ML system is further configured to:
transmit the first representative alert to the security analytics platform for evaluation and then receive an evaluation of the first representative alert from the security analytics platform.

3. The computer system of claim 2, wherein the ML system is further configured to:
transmit a second representative alert of a group of second alerts of the security alerts before transmitting the first representative alert, based on the second alerts being from a second cluster of the clusters that is associated with malicious activity.

4. The computer system of claim 1, wherein the ML system determines that the first alerts belong to the first cluster by creating a hash for each of the first alerts, of a command line that triggered the first alert, and by determining that for each of the first alerts, a distance between the hash and the center of the first cluster is less than a threshold.

5. The computer system of claim 1, wherein a difference between each of the first alerts across a set of features of the first alerts is less than a threshold, the features of the first alerts including whether digital signatures were present in command lines that triggered the first alerts and reputations of processes in the command lines.

6. The computer system of claim 1, wherein the first alerts are received from the same endpoint of the endpoints over a predetermined time interval.

7. The computer system of claim 1, wherein the ML system is further configured to:
determine that a group of second alerts of the security alerts belongs to a second cluster of the clusters;
create a second representative alert from metadata of the second alerts belonging to the second cluster; and
in response to the security analytics platform evaluating the second representative alert as being malicious to the computer system, store information indicating that all of the second alerts are malicious.

8. A method of aggregating security alerts for a computer system, wherein the computer system includes a plurality of endpoints at which security agents generate security alerts and a machine-learning (ML) system that receives the security alerts from the endpoints and that separates the security alerts into a plurality of clusters, the method comprising:
determining based on entire command lines that triggered a group of first alerts of the security alerts, that the first alerts all belong to a first cluster of the clusters;
creating a first representative alert from metadata of the first alerts belonging to the first cluster; and
in response to a security analytics platform evaluating the first representative alert as being harmless to the computer system, storing information indicating that all of the first alerts are harmless.

9. The method of claim 8, further comprising:
transmitting the first representative alert to the security analytics platform for evaluation and then receiving an evaluation of the first representative alert from the security analytics platform.

10. The method of claim 9, further comprising:
Transmitting a second representative alert of a group of second alerts of the security alerts before transmitting the first representative alert, based on the second alerts being from a second cluster of the clusters that is associated with malicious activity.

11. The method of claim 8, wherein the ML system determines that the first alerts belong to the first cluster by creating a hash for each of the first alerts, of a command line of the command lines that triggered the first alert, and by determining that for each of the first alerts, a distance between the hash and the center of the first cluster is less than a threshold.

12. The method of claim 8, wherein a difference between each of the first alerts across a set of features of the first alerts is less than a threshold, the features of the first alerts including whether digital signatures were present in the command lines that triggered the first alerts and reputations of processes in the command lines.

13. The method of claim 8, wherein the first alerts are received from the same endpoint of the endpoints over a predetermined time interval.

14. The method of claim 8, further comprising:
determining that a group of second alerts of the security alerts belongs to a second cluster of the clusters;
creating a second representative alert from metadata of the second alerts belonging to the second cluster; and
in response to the security analytics platform evaluating the second representative alert as being malicious to the computer system, storing information indicating that all of the second alerts are malicious.

15. A non-transitory computer-readable medium comprising instructions that are executable in a computer system, wherein the computer system includes a plurality of endpoints at which security agents generate security alerts and a machine-learning (ML) system that receives the security alerts from the endpoints and that separates the security alerts into a plurality of clusters, and wherein the instructions when executed cause the computer system to carry out a method of aggregating the security alerts, the method comprising:
determining that a group of first alerts of the security alerts belongs to a first cluster of the clusters, wherein a group of second alerts of the security alerts assigned to the first cluster were previously evaluated as being harmless;
creating a first representative alert from metadata of the first alerts belonging to the first cluster; and
in response to a security analytics platform evaluating the first representative alert as being harmless to the computer system, storing information indicating that all of the first alerts are harmless.

16. The non-transitory computer-readable medium of claim 15, wherein the method further comprises:
transmitting the first representative alert to the security analytics platform for evaluation and then receiving an evaluation of the first representative alert from the security analytics platform.

17. The non-transitory computer-readable medium of claim 16, wherein the method further comprises:
transmitting a second representative alert of a group of third alerts of the security alerts before transmitting the first representative alert, based on the third alerts being from a second cluster of the clusters that is associated with malicious activity.

18. The non-transitory computer-readable medium of claim 15, wherein the ML system determines that the first alerts belong to the first cluster by creating a hash for each of the first alerts, of a command line that triggered the first alert, and by determining that for each of the first alerts, a distance between the hash and the center of the first cluster is less than a threshold.

19. The non-transitory computer-readable medium of claim 15, wherein a difference between each of the first alerts across a set of features of the first alerts is less than a threshold, the features of the first alerts including whether digital signatures were present in command lines that triggered the first alerts and reputations of processes in the command lines.

20. The non-transitory computer-readable medium of claim 15, wherein the first alerts are received from the same endpoint of the endpoints over a predetermined time interval.
